(19) United States
(12) Patent Application Publication
(10) Pub. No.: US 2010/0310862 A1
(43) Pub. Date: Dec. 9, 2010

(54) ADHESIVE FORMULATIONS AND MULTILAYERED ASSEMBLIES

(76) Inventor: Maya Efraty, Tel Aviv (IL)

Correspondence Address: GREENBERG TRAURIG, LLP, MET LIFE BUILDING, 200 PARK AVENUE, NEW YORK, NY, 10166, US

(21) Appl. No.: 12/676,843

(22) PCT Filed: Sep. 4, 2008
(86) PCT No.: PCT/IL2008/001196

§ 371 Date: May 6, 2010

Related U.S. Application Data
(60) Provisional application No. 60/935,886, filed on Sep. 5, 2007.

(51) Int. Cl. B32B 37/12; C09J 191/06; B32B 5/00

(52) U.S. Cl. 428/336; 106/270; 106/272; 156/60

(57) ABSTRACT

The invention disclosed in this application, relates to an adhesive formulation and uses thereof, in the manufacture of multilayered assemblies, for various applications.

### FIELD OF THE INVENTION

This invention generally relates to an adhesive formulation and uses thereof, e.g., in the manufacture of multilayered assemblies, e.g., sheets, films, for various applications.

### BACKGROUND OF THE INVENTION

Articles manufactured from materials such as polyethylene polymers and paper materials, are widely accepted in the marketplace for a variety of applications, ranging from high density polyethylene, which are used to contain such materials as household cleaners, to paper bags. The variety of uses necessitates the manufacture of durable and preferably re-usable or recyclable materials in a cost effective way.

Multilayer polymer or paper films used in packaging as either single sheets to wrap products or converted into bags into which products are loaded must meet demanding criteria from both the industrial and end-user perspectives. These criteria may include the strength of the film and the frictional nature thereof. Such criteria may depend on the nature of the material making the multilayered sheets as well as on the magnitude of adherence of adjacent film surfaces as determined, among other parameters, on the nature of the adhesive employed.

Adherence of such surfaces to each other is typically achieved by the use of hot melt adhesives, with the majority of which comprising polymers, tackifiers, wax, and additives. The existence of polymers in such adhesives limits the ability to produce a thin bonding without employing high energy input, e.g., high pressures. Thin-layer bonding is not possible where very low or even zero pressure is allowed during application (e.g., lamination). Additionally, such adhesives are more difficult to apply as thin layers due to their viscosity which also limits the adhesive ability to impregnate very fine porous layers. In many applications, where the laminated or bonded layers are bonded by thick adhesive, the assembly is susceptible to peel and delamination.

Known adhesive formulations comprise typically high molecular weight polymeric materials which prevent fast swelling into the substrate by way of penetration into the amorphous domains in, e.g., polymeric substrates, or penetration into porous substrates such as wood, paper, leather, textile and etched metals. Moreover, the high molecular weight polymers are less compatible with wax and additives, and phase separation may occur.

Not less importantly, as such polymeric materials are typically petroleum-based, the adhesive formulations comprising them tend to be environmentally non-friendly, and as such, their cost is expected to increase dramatically in the future.

### SUMMARY OF THE INVENTION

Thus, for applications where a thin adhesive layer (e.g., less than 10 micrometers or less than 5 micrometers, after wetting, swelling and/or impregnating substrate and cooling) is desired, and/or where the use of low pressure and temperature is a limiting factor (e.g., so as to avoid weld line marks on outer surface of laminate or label, and/or where very fast—less than about 30 seconds—wetting and/or swelling of substrate are required), there remains along felt need for an improved adhesive formulation for bonding, e.g., laminating two or more surfaces.

In other words, there exists the need for an adhesive formulation having low viscosity, which requires low temperature and pressure for application and at the same time provide a low energy and environmentally friendly alternative to many of the adhesive formulations of the art. Additionally, there exists a need for an adhesive formulation which can exhibit fast impregnation into or swelling of the substrates to be bonded to allow manufacture of assemblies having thin bond line, with minimal or no excess adhesive material remaining between the bonded plies.

The inventors of the present invention have now developed a hot-melt adhesive formulation having such desired characteristics. The ability to bond polymeric substrates, typically in the form of films or sheets made of e.g., polyolefines or polar polymers or having such a surface, and provide laminates of high quality, finds its basis in an innovative combination of natural or semi-natural products. This innovative combination may employ the same or related natural or semi-natural ingredients or equivalently employ synthetic or semi-synthetic ingredients, endowing the combination with the same or similar adhesive properties.

The natural or semi-natural products comprising natural waxes, natural diluents and natural swelling agents or equivalent synthetic ingredients, enable simple and low-cost bonding of, e.g., polyolefinic or other thermoplastic polymeric surfaces, e.g., films or sheets, to each other and the formation of e.g., multilayered assemblies suitable for further processing and shaping.

Thus, the present invention provides a non-reactive adhesive (namely, an adhesive which may be re-melted or re-dissolved after application) formulation for bonding a first substrate to a second substrate, said bonding being provided by an adhesive formulation having one or more of the following: a low viscosity; a low melting point; requires minimal input of energy (e.g., temperature and/or pressure) for application; exhibits fast impregnation into porous or fibrous substrates to be bonded (less than about 30 seconds); exhibits fast swelling of polymeric substrates to be bonded (less than about 30 seconds); substantially impregnates and/or swells substrates to be bonded; produces bonded assemblies having thin bond lines (lower than 10 microns, and even lower than 5 microns in thickness); being environmentally friendly; being biodegradable; and being repulpable, all of which characteristics being as disclosed herein.

In some embodiments, the non-reactive adhesive formulation is characterized by a low viscosity and a low melting point, as disclosed herein.

In further embodiments, the non-reactive adhesive formulation is characterized by a viscosity enabling the manufacture of a bonded assembly having a thin bond line, as disclosed herein.

In additional embodiments, the non-reactive adhesive formulation comprises:

(1) at least one low molecular weight material having one or more of:
(i) chemical affinity towards at least one of said first and second substrate; and
(ii) a solubility parameter being substantially the same or one and a half units (1.5) greater or smaller than the solubility parameter of either of said first and second substrate;

(2) at least one swelling promoter; and

(3) optionally at least one additive.

As use herein, the term “substrate” refers in its broadest definition to a solid object, typically being in the form of a sheet, leaf, film or any other three-dimensional structure. The substrate may be of any thickness, any texture and may also be in the form of a hybrid substrate comprising different regions of different (or same) materials. Where the substrate is referred to in respect of its chemical composition, e.g., “a polyolefinic substrate”, such a reference stands to reflect on the composition at a surface coming into contact with the adhesive formulation. For example, within the context of the present invention, “a polyolefinic substrate” refers to an object having a polyolefin surface or having certain regions of its surface (one or more) polyolefinic in nature. Such a substrate may be a continuous (or non-continuous) sheet or a film of a polyolefin, a base material such as a metal sheet coated on at least a portion of its surface with a polyolefin, etc. Where the substrate to be bonded with another is, e.g., a “polyolefinic substrate” in the form of, e.g., a metal base partially coated with a polyolefin, bonding is achieved, in accordance with the invention, through at least a portion of its polyolefinic coat.

Thus, the expression “at least one low molecular weight material having chemical affinity towards at least one of said first and second substrate” refers to the chemical affinity, as defined herein, to a region of the substrate's surface on which the adhesive formulation is applied.

The at least one low molecular weight material is selected so as to have the same or similar physical properties as the surface of the substrate on which the adhesive is to be applied. In some embodiments, the low molecular weight material has chemical affinity towards the first and/or second substrates. As used herein, the term “chemical affinity” refers to the ability of the at least one low molecular weight material to interact with a surface of one or both of said first and second substrates through one or more of covalent bonding, ionic interaction, polar interaction (ranging from van der waals interactions through hydrogen bond interactions) and hydrogen bonding.

In other embodiments, the low molecular weight material has the same or similar solubility parameter as the first and/or second substrates. The solubility parameter refers to the Hildebrand solubility parameter (δ) which provides a numerical estimate of the degree of interaction between materials, as measured in the units of a square root of megapascals ((MPa)^{1/2)}).

In further embodiments, the at least one low molecular weight material has a chemical affinity towards one or both substrate and also the same solubility parameter as either or both substrates.

In some embodiments, the at least one low molecular weight material is a combination of two or more such materials, each having an averaged molecular weight (MW), as determined by gel permeation chromatography, of less than about 5,000 daltons (Da). In some embodiments, the molecular weight is less than about 2,500 Da; and in further embodiments, less than about 1,000 Da.

The at least one low molecular weight material employed in the adhesive formulation of the invention may also be selected amongst materials having intrinsic viscosities of lower than 0.5 deciliter/gram at 135° C., e.g., for semi-crystalline polymers and intrinsic viscosities of lower than 0.5 deciliter/gram at 30° C., e.g., in an organic solvent, for amorphous polymers, oligomers or non-polymeric organic compounds.

The at least one low molecular weight material may thus be selected from amorphous propylene homopolymers such as Licocene™ manufactured by Clariant; ethylene copolymers such as Eastoflex™ P1010, M1010, E1060 and D178 (manufactured by Eastman); and polymers or oligomers having been treated by oxidation or by grafting with polar groups such as for example maleic anhydride, acrylic acid, glycidyl, hydroxyl, amide and ester. Such polar polymers or oligomers are, for example, the modified polyolefins known as Epolene™ E-20 and E-25 (manufactured by Eastman), Licocene™ PEMA 4221 TP and PEOX 4241 (manufactured by Clamant). In some embodiments, the at least one low molecular weight material is selected from polybutene resins, such as Indopol™H-6000 (manufactured by BP chemicals).

The at least one swelling agent employed in the adhesive formulation of the invention is selected so as to endow the adhesive formulation with the ability to diffuse (to a compatible blend, via any physical mechanism) into the substrate on which the adhesive is applied in a more effective manner. The use of at least one swelling agent in the formulation of the invention thus provides the benefit of (1) employing less or no pressure onto the substrates to be bonded for establishment of bonding and (2) the use of substantially lower temperatures so as to afford bonding.

The at least one swelling agent is a low molecular weight compound capable of swelling polymeric substrates (e.g., a polymeric surface). The at least one swelling agent employed is selected to have one or more of:

1. a solubility parameter substantially the same or one and a half (1.5) units smaller or greater than the solubility parameter of either or both the first and second substrate to be bonded;

2. the ability to promote swelling of the surface at ambient temperature or at a temperature 20° C. above the peak annealing temperature or softening temperature of either or both of the substrates to 75° C. below the substrate peak annealing temperature or softening temperature of either or both of the substrates, so that a weight gain (i.e., the increase in weight due to swelling) of a substrate in the bonding area, of at least 10% is observed within at most 1 minute post application, for a substrate being 100 micrometer thick;

3. does not leach from the substrate or bonded substrates; and

4, the ability to lower the modulus of elasticity of the substrate, as measured 24 hours after bonding, by at least 5%.

Such swelling agent may be selected amongst agents having an averaged molecular weight of lower than 500 Da.

In some other embodiments, the at least one swelling agent is selected amongst compounds having a flexible, non-branched carbon chain. Non-limiting examples of swelling agents are fatty acids such as stearic acid, oleic acid, linoleic acid, linolenic acid, Tall oil fatty acid (being a mixture containing long-chain unsaturated fatty acids obtained as a byproduct of the wood pulping process) and behenic acid; polymerized fatty acids and hydrogenated polymerized fatty acids (typically manufactured by heating long-chain unsaturated fatty acids, e.g., C₁₈ or more monocarboxylic acids, to about 200-250° C. in the presence of a clay catalyst to produce dimer acid, and trimer acid); fatty alcohols, such as 1-eicosanol, 1-docosanol (behenyl alcohol), dotriacontanol, tetratriacontanol, pentatriacontanol, tetracontanol, tetraacontanol, dopentaacontanol, tetrahexaacontanol, dohexaacontanol, including esters, carbamates, and ethers thereof; Paraffin oils and waxes; Bee wax; Japan wax; aliphatic amide waxes, e.g., stearamide wax, behenamide wax, and bis-stearamide wax; fatty acid waxes; amine waxes; vegetable waxes such as carnauba wax and castor wax; polyethylene waxes; synthetic paraffin waxes; hydroxylated fatty acid waxes; oxazoline waxes, microcrystalline waxes; modified microcrystalline waxes; oxidized mineral waxes such as montan waxes; bamboo leaf wax, certain beeswaxes, caranda wax, Chinese insect, cotton wax, cranberry wax, certain Douglas-fir bark, asparto wax, certain flax, Indian corn, Madagascar corn wax, ouricery wax, ozocerite wax, palm wax, peat wax, rice bran wax, shallas wax, sisal hemp wax, sorghum grain wax, Spanish moss wax, refined sugar cane wax, and mixtures thereof.

In some other embodiments, the at least one swelling agent is selected amongst ester, amide, anhydride and salt derivatives of said fatty acids.

In some embodiments, where at least one of said first and second substrates to be bonded is a non-polar material, such as low density polyethylene (LDPE), high density polyethylene (HDPE), polypropylene (PP) including co-polymer of polypropylene, and ethylene-alpha olefin plastomers, the adhesive formulation comprises a low viscosity polymer selected from amorphous propylene homopolymers, such as Eastoflex™ P1010 (having a viscosity of 1,000 cps at 190° C.); polypropylene/propylene-ethylene copolymers such as Eastoflex™ M1010 (having a viscosity of 1,000 cps at 190° C.); propylene-ethylene copolymers such as, Eastoflex™ E1060 (having a viscosity of 6,000 cps at 190° C.) and Eastoflex™ D178 (having a viscosity of 3,000 cps at 190° C.), and at least one swelling agent, e.g., stearic acid, glycerol mono-oleate, paraffin oil or paraffin wax, wherein the Eastoflex™ polymers are manufactured by Eastman.

In other embodiments, where said adhesive formulation, or generally any formulation according to the invention comprises non-petroleum ingredients (i.e., materials derived from fruits, vegetables, seeds and animals), it may further comprise a natural wax selected from beeswax, carnuba wax, stearamide wax, behenamide wax, and at least one diluent and/or at least one swelling agent such as a fatty acid or a fatty alcohol.

In still further embodiments, where at least one of said first and second substrates is a polar substrate selected from polyester such as polyethyleneterephthalate (PET), polyvinyl chloride (PVC), cellulose esters, polyamide, polycarbonate and ethylene vinyl acetate (EVA), the formulation according to the invention comprises a low viscosity polymer being selected from oxidized or chemically modified polyolefins such as Epolene™ E-20 and E-25 (manufactured by Eastman), and Licocene™ PEMA 4221 TP and PEOX 4241 (manufactured by Clariant); polybutene resins, such as Indopol™H-6000 (manufactured by BP chemicals); and at least one swelling agent such as a fatty acid, a fatty acid ester, a fatty alcohol, a dimer acid, beeswax and a paraffin wax.

In some embodiments, said at least one low molecular weight material is beeswax.

In some embodiments, the adhesive formulation comprises:

(1) at least one wax selected from beeswax, paraffin wax, Japan wax, and

(2) hydroxyoctacosanyl hydroxystearate.

In some embodiments, the adhesive formulation comprises two waxes selected from beeswax, paraffin wax, Japan wax and carnauba wax. In related embodiments, said two waxes are beeswax and paraffin wax. In other embodiments, the two waxes are beeswax and Japan wax.

In further embodiments, the beeswax is selected from natural beeswax and synthetic beeswax. Beeswax has a mixture of numerous components such as hydrocarbons, esters (mono-, di-, and tri-), hydroxyl esters, acid esters, polyesters, acids and alcohols. The main components of beeswax are palmitate, palmitoleate, hydroxypalmitate and oleate esters of long chain aliphatic alcohols. The beeswax employed by the present invention may be any naturally or commercially available beeswax, having a melting point between 62 and 64° C. and a density of between 0.958 and 0.970 g/cm³ at 15° C.

The carnauba wax is another naturally or commercially available wax derived from the leaves of the carnauba palm. The wax comprises mainly esters of fatty acids, fatty alcohols and hydrocarbons. The carnauba wax employed by the invention, may be any naturally or commercially available carnauba wax, having a melting point of between 78-85° C. and a relative denisty of about 0.97.

Paraffin wax is a white, odorless solid, with a melting point between about 47 and 64° C. The paraffin is typically employed by the invention in combination with stearine which conforms to the paraffin wax certain charcahtaristics which are needed in the bonding of surfaces according to the invention.

Japan wax is a pale-yellow solid which comprises, similarly to the other waxes employed herein, a mixture of compounds such as palmitin, stearine and olein. The Japan wax employed by the invention, may be any naturally or commercially available wax, having a melting point in the range of 51 and 54° C.

The adhesive formulation may further comprise at least one additive selected from a diluent, an adhesion promoter, a heat stabilizer, a pigment, a dye, a light stabilizer, filler, a fiber, a nanoparticle, a carbon black, a tackifier and a coupling agent.

In some embodiments, the adhesive formulation comprises at least one diluent, being a low molecular weight compound selected to be capable of lowering the viscosity of the adhesive formulation at the molten state. Non-limiting examples of such a diluent are polybutene, paraffin oil, silicone oil, vegetable oils such as corn oil, castor oil, flax oil, plasticizers such as alkyl adipates, alkyl phthalates and phosphate esters and organic solvents such as ketones, esters, alcohols and aromatics.

The adhesive formulation, in other embodiments, comprises at least one adhesion promoter, being a low molecular weight compound, miscible in the formulation and having at least one functional group having affinity and/or reactivity towards the substrate, e.g., olefinic substrate. The at least one functional group may or may not be reactive towards the substrates.

Non-limiting examples of such adhesion promoters are organo silanes, organo titanates, organo zirconates, polymers and oligomers having acid number greater than 10 milligrams KOH per gram compound, di isocyanates and poly isocyanates such as bonding agent 2001 manufactured by Bayer, and organic acids—e.g., compounds having more than two acidic groups per molecule such as Silvaros PR295 manufactured by Arizona chemical.

The adhesive formulation of the invention may be formulated in numerous ways to fine-tune its functionality to a specific application. In some embodiments, the adhesive formulation is characterized by a viscosity of 250-5 cps at 190° C. (mPa·s according to ASTM D3236), and/or a viscosity of 300-5 cps at 177° C., and/or a viscosity of 1000-5 cps at 150° C., and/or a viscosity of 2000-5 at 140° C., and/or a viscosity of 5000-5 at 125° C., the viscosity being measured by a thermoset viscometer (manufactured by Brookfield), spindle SC4-18.

The adhesive formulation of the invention may be used for bonding a great variety of surfaces. Thus, the present invention also provides the use of an adhesive formulation according to the present invention in a process for bonding at least two substrates to each other, e.g., bonding a first substrate to a second substrate and optionally to further substrates.

In some embodiments, one of said first and second substrates is a polyolefin. In other embodiments, both of said substrates are polyolefins. Non-limiting examples of such polyolefinic substrates are those made of or have a surface of polyethylene, ethylene co-polymers and terpolymers, ethylene-vinyl acetate, polypropylene including homopolymer or co-polymers thereof, and ethylene-alpha olefin plastomers.

In some embodiments, the polyolefin substrate/surface is polyethylene.

The adhesive formulation according the present invention is additionally useful for bonding polar substrates such as polyesters, polyamides, polyurethanes, co-polyesters, ionomer, cellulose esters, polyvinyl chloride, paper, leather wood, concrete, ceramics, glass, metals such as aluminum and ferrous metals, metal oxides, metal phosphates, metal chromates as well as barrier layers such as polyvinylidene chloride.

The first and second surfaces may each, independently of each other, be a polar substrate selected amongst metal or metal-alloy substrates, paper, as well as other cellulose based fibrous substrates such as wood, textiles, cardboard and natural fibers. Such polar surfaces may be bonded to each other or to one or more olefin substrates as defined.

The process of the invention for bonding a first substrate to a second substrate, thus, comprises:

(1) obtaining a first and a second substrates;

(2) applying a flowable form of an adhesive formulation of the invention to at least a region of a surface of one or both of said first and said second substrates;

(3) optionally aligning one or both of said first and second substrates into contact with each other, i.e., so as to allow the adhesive formulation applied onto the surface of one or both of the substrates to come into contact with the surface of the other substrate; and

(4) applying at least one of temperature and pressure to the first and second substrates being in contact with each other, at least at the region of desired bonding, to allow bonding of said first substrate to said second substrate.

In some embodiments, the flowable form of said adhesive formulation is a liquid form thereof, e.g., a liquid form obtainable at a temperature above the melting temperature of the adhesive formulation.

In further embodiments, the temperature applied to said first and second substrates being in contact with each other is a temperature between ambient temperature and a temperature 20° C. above the peak annealing temperature or softening temperature of either of the substrates to 75° C. below the peak annealing temperature or softening temperature of either of the substrates. In some embodiments, the temperature is ambient temperature (25-27° C.).

In some embodiments, the process of the invention does not necessitate the application of pressure to the substrates to promote bonding. In other embodiments, the pressure applied is at most 0.1 megapascals (MPa). In other embodiments, the pressure applied is at most 0.01 megapascals (MPa).

In further embodiments, the pressure applied is at most 1 megapascals (MPa).

The term “bonding” as used herein refers generally to any one term relating to the joining together of two or more substrates, e.g., films, flat surfaces, etc. The bonding employing the adhesive formulation results in an assembly of two or more films having one or more points of bonding or a “laminate” wherein one surface completely laminates the other. The laminate of the invention may be an assembly, e.g., a laminate, of any number of films (e.g., substrates or layers) bonded to each other through one or more points of bonding on the surface of one or more of the films. The assembly of the invention may also be of the same or different film materials. The assembly may be a stacked laminate, or a stacked assembly, wherein the assembly of one or more films is coaxially oriented or a continuous assembly wherein the point(s) of bonding between each film is at one or more ends thereof. The assembly according to the invention may also take the form of a pouch that is sealed on one or more of its sides, with the inner surface of both films making the pouch are substantially unbonded. The pouch may be an arrangement derived from two or more separate films or from a single continuous film having been folded around one of its axis to form the pouch.

Thus, the present invention provides an assembly, e.g., a laminate, having at least two films bonded to each other through at least one region on the surface of both films, said bonding being provided by an adhesive formulation according to the invention.

In some embodiments, the at least two films (or at least one film being folded onto itself) are arranged coaxially. In other embodiments, the at least two films (or at least one film being folded onto itself) are arranged so as to form a continuous surface.

In some embodiments, the at least two films are bonded to each other through at least one non-continuous region. In other embodiments, the at least two films are bonded to each other through one or more continuous regions. In some embodiments, the at least two films are bonded to each other through multiple regions on each of their surfaces. In some additional embodiments, bonding of the at least two films is achieved through bonding of the whole surface of one film to another whole surface of the other film.

The adhesive layer (the adhesive material between the two substrates) bonding said at least two substrates through at least one region on their surfaces is characterized by one or more of the following:

(1) thickness (as measured at end of the bonding process, 24 hours or more after cooling of the adhesive) of less than 10 micrometers; and

(2) penetration into each of the bonded substrates by at least 1 micrometer, wherein said penetration is via impregnating the surface porosity and/or by swelling the amorphous domains and/or by melting or dissolving the crystalline domains in one or both of the substrates' surfaces. The result is a modified substrate comprising a blend of original substrate and adhesive.

As a person skilled in the art would appreciate, contrary to known bonding or lamination processes, the use of an adhesive formulation according to the invention allows the manufacture of an assembly or a laminate being substantially free of adhesive material between the (laminate) plies. Without wishing to be bound by theory, such a unique characteristic results from the impregnation of the adhesive molecules into the film(s) material and/or by swelling the film(s) to allow penetration thereinto.

In fact, when a region of the assembly manufactured with an adhesive formulation according to the invention is removed from the site of bonding and the substrates making up the assembly are separated, no adhesive material is found on the surface of either substrate. Differential scanning calorimetry (DSC) analysis of either of the substrate having been so separated show the existence of at least two melting peaks or softening zones (for amorphous substrates such as PVC or polycarbonate): one associated with the substrate itself typically being a melting peak at a higher temperature and the other associated with the adhesive material or portion thereof having been penetrated, swollen or impregnated thereinto. This is not observed when an assembly of two substrates is formed utilizing an adhesive not having the characteristics disclosed herein. When a region from such an assembly is removed and the substrates separated, substantial amounts of adhesive material are found between the separated plies. When the adhesive material is removed and the DSC of either of the substrates is measured, a single melting peak is observed, associated with the substrate alone. A second melting peak relating to the adhesive material is not observed.

Thus, articles having better physical performances may be manufactured for a great variety of applications, e.g., for packaging and structural lamination, to endow such with one or more of lower permeability to liquids or gases; improved chemical resistance; higher strength and resistance to delamination; lower cost of raw materials and energy per unit area of bonded and/or laminated assembly; lower energy consumption for producing unit area; thinner substrates are enabled, since lower temperatures and pressures are less harmful to thin substrates; flexibilized and plasticized substrate in the bonding area, that prevents the typical brittleness of welded seams and assemblies; low content of petroleum based compounds; biodegradable; and for paper based laminates, also repulpable.

The assembly or laminate according to the present invention is an assembly of two or more films. In some embodiments, the assembly is a multilayered assembly being generally of individual films, layers, which are described in terms of: a first, outer or skin layer; a core or second layer; and a third, outer or skin layer, wherein the second layer is located between the first and third layers, with such designations being for reference only.

The multilayered assembly may include additional layers between the first and second layers and/or the second and third layers. As will be further discussed hereinbelow, the individual layers may be different or same in terms of material, thickness, size, color, texture, etc.

The individual layers of the assembly are bonded to each other with an adhesive formulation according to the present invention. However, the assemblies according to the invention may also utilize in addition to an adhesive as herein disclosed also commercially or other known adhesive materials.

Although referred to as an assembly, it should be understood that the multilayered structure is a sheet or film which may have thickness of between 0.1 millimeter to several millimeters or more, depending on the nature of the layers (e.g., plastic versus wood or metal layers), the thickness of the individual layers, the texture of the final product, the adhesive material and quantity thereof and on various processing parameters.

The multilayered assembly of the invention, thus prepared may have 2 or more individual layers bonded (blocked, glued) to each other with said an adhesive formulation or a formulation comprising it. In some embodiments, the assembly has between 2 and 20 layers. In other embodiments, the assembly has between 2 and 15 layers. In still further embodiments, the assembly of the invention has between 2 or 4 and 10 layers, e.g., the assembly is of 2, 3, 4, 5, 6, 7, 8, 9, or 10 layers.

In other embodiments, the assembly is of 11, 12, 13, 14, 15, 16, 17, 18, 19 or 20 layers.

As recited above, where the assembly has two layers, one or both of said layers may be coated with an adhesive formulation at the at least one region of desired bonding. For example, where the at least one region of bonding is at the center of two coaxially oriented films, the adhesive formulation may be applied to a region at the center of one or both of the films. Where the at least one region of desired bonding is two regions, each being continuous or non-continuous, the adhesive formulation may be applied to each of the films at each of the two regions of bonding or to one film at one of the regions and to the other region of the second film. Where a third layer is present, the layer to be placed between the first and third layers may be coated with the adhesive formulation on one or both of its face.

Thus, the method of the invention further comprises placing a third layer on top of the second face of said second layer and bonding the three-layer assembly is ensued.

The multilayered assemblies thus obtained, may be of any material or any combination of materials, and of any thickness. Typically, the individual single layers comprise homopolymer, copolymer, or blends thereof.

In some embodiments, the layers comprise of or are low density polyethylene (LDPE), for example LDPE having a high degree of long-chain branching and a density ranging from about 0.915 to about 0.935 g/cc. A LDPE suitable for use in the fabrication of the multilayered assemblies of the invention is any LDPE including recyclable LDPE such as plastic bags, commercially available LDPE and preformed LDPE. Suitable LDPE and methods for preparing it are well known to one with ordinary skill in the art.

In other embodiments, the layers comprise of or are high density polyethylene (HDPE).

In yet other embodiments, the layers comprise of or are polypropylene (PP).

In still other embodiments, the layers comprise wood fibers and other wood products.

In other embodiments, the layers are textile layers made of natural fibers, mineral fibers, synthetic fibers or mixtures thereof.

In further embodiments, the layers are metallic layers of various thicknesses and composition.

The plurality of layers making up the multilayered assembly of the invention may be of each of a different material, texture, color, thickness, and different physical properties.

In some embodiments, the multilayered assembly is constructed of layers of LDPE. In other embodiments, the assembly is constructed of layers of LDPE and HDPE. In further embodiments, the inner layers are LDPE and the outer layers are HDPE.

The coating of a face of a layer with an adhesive formulation may be achieved by any method known to a person skilled in the art, such as brushing, spraying, and dipping, extrusion coating, curtain coating and roller coating.

In some embodiments of the invention, the coating of a certain layer with an adhesive material according to the invention, so as to afford bonding with a second certain layer, may be replaced with placing between the two layers a solid pre-made sheet of an adhesive formulation. Such pre-made sheets of one or more adhesive formulations according to the invention, may be prepared by e.g., molding the adhesive formulation at a temperature below its melting temperature, e.g., under heat and pressure, into a sheet of a desired size, thickness and consistency.

The bonding of any at least two layers employing the adhesive formulation, whether applied to the face of the layer by brushing, spraying or dipping, or placed as a sheet between the layers to be bonded, may be achieved, depending also on the overall thickness of the assembly, by any one of the following methods:

1. pressing the assembled layers at room temperature for a period of time sufficient to allow bonding of layers;

2. heat-pressing the assembled layers at a temperature above room temperature for a period of time sufficient to allow bonding of layers;

3. heat-pressing the assembled layers at a temperature above the melting point of each of the adhesive formulation employed, for a period of time sufficient to allow bonding of layers;

4. heat-pressing the assembled layers at different stages of the process, involving any one of the methods (1) to (3) above; and

5. heating without pressing the assembled layers at a temperature above the melting point of the adhesive formulation.

In some embodiments, the assembly is heat-pressed at a temperature being above the melting temperatures of the adhesive materials used. In some embodiments, said temperature is between 45 and 120° C.; between 45-100° C.; between 45-85° C.; between 50 and 150° C.; between 70 and 150° C. or between 90 and 150° C.

Although in some embodiments, pressing may not be necessary, where pressing is desired, it may be achieved by any press known to a person skilled in the art. Where the multilayered assembly manufactured is large, the pressing may be one portion at a time, may be continuous under a roller capable of pressing the full width of the assembly or may be under a press of the same size.

The pressing period and pressures employed depend on numerous factors such as the layer material or combination thereof, thickness, type of adhesive formulation used, quantity of adhesive employed, size of the multilayered assembly required, desired texture and other processing factors.

Typically, the pressing period is between a few seconds to a few minutes. In some embodiments, the pressing period is between 10 and 120 seconds. In other embodiments, the pressing period is between 10 and 60 seconds.

In some embodiments, the pressing pressures employed may also vary. In one embodiment, the minimum pressure is about 200 g/cm s² (20 Pa, being less than 1 MPa). In another embodiment, the pressure applied is between 200 g/cm s² and 1000 g/cm s². In a further embodiment, the pressure applied is between 200 g/cm s² and 500 g/cm s².

In the process, additives such as colorants, UV stabilizers, flame retardants, humidity sealers, reinforcing materials, metal particulates, fibers and others may be added to impart to the final product at least one physical or chemical characteristic. The additives may be added in the process of assembling the layers or as part of any one of the layers or the adhesive formulation.

Additionally, a print layer or the like may be located on the surface of the first or third layer or both. Similarly, a fourth layer may be laminated to the surface of the first or third layer.

In another aspect of the invention, there is provided a multilayered assembly manufactured according to the process of the invention.

In still another aspect of the invention, there is provided a multilayered assembly having at least two layers, wherein bonding is provided by an adhesive formulation comprising beeswax, hydroxyoctacosanyl hydroxystearate, paraffin wax, Japan wax, carnauba wax, gelatin.

In another aspect, there is provided an article manufactured from or comprising any one of the multilayered assemblies of the invention.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It should also be noted that where various embodiments are described by using a given range, the range is given as such merely for convenience and brevity and should not be construed as an inflexible limitation on the scope of the invention. Accordingly, the description of a range should be considered to have specifically disclosed all the possible sub-ranges as well as individual numerical values within that range. For example, a “melting point between 60 and 75° C.” should be considered to have specifically disclosed sub-ranges such as from 60 to 74, from 60 to 73, from 60 to 72, . . . etc., as well as from 61 to 75, from 61 to 74, from 61 to 73, from 61 to 72, . . . etc., as well as from 60 to 75, from 60 to 74, . . . etc., as well as individual values within that range, in this example, 60, 61, 62, 63, 64, 65, 66, 67, 68, 69, 70, 71, 72, 73, 74, and 75° C.

Further, it is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a cross-sectional view of a two-layered assembly according to the invention;

FIG. 2 is a cross-sectional view of a two-layered assembly coated with a film of paraffin;

FIG. 3 depicts the constructions of a three-layered assembly according to the invention;

FIG. 4 is a cross-sectional view of a four-layered assembly according to the invention;

FIG. 5 is a cross-sectional view of a reinforced assembly according to the invention.

### DETAILED DESCRIPTION OF EMBODIMENTS

Various embodiments and aspects of the present invention as delineated hereinabove and as claimed in the claims section below find experimental support in the following examples.

### Example 1

### A Low Melting Point Adhesive for Bonding Polyethylene Films

Two low-melting formulations according to the invention were tested for use as hot-melt adhesives for bonding LDPE films (75 micrometers thick). The formulations and lamination conditions are listed in Table 1 below. The welding temperature, welding pressure, adhesive layer thickness (after cooling), lap shear strength and peel strength were measured for each of the formulations and also for formulations substantially consisting a single component of the adhesive formulations.

As the results of Table 1 indicate, assemblies (e.g., laminates) prepared by bonding polyethylene films to each other, with the bonding being provided by the adhesive formulation 4 or 5, according to the present invention, demonstrated higher peel strength and lap shear strength in comparison with the other formulations, indicating a more efficient bonding of the layers.

TABLE 1

| | | | | | Adhesive | | |
|---|---|---|---|---|---|---|---|
| | | Viscosity | | | layer | Lap shear | |
| | | (centipoises) | Welding | Welding | thickness | strength | Peel |
| Adhesive | | At 150 | temperature | pressure | (after | (Kilopascal | strength |
| number | formulation | Celsius | (Celsius) | (MPa) | cooling) | (KPa)) | (N/mm) |
| 1 | Bees wax | Lower than | 110 | 0.02 | 6 | 27 | Lower |
| | only | 100 | | | | Adhesive | than 0.01 |
| | | | | | | failure | |
| 2 | Stearic acid | Lower than | 110 | 0.02 | 6 | 29 | Lower |
| | only | 100 | | | | Adhesive | than 0.01 |
| | | | | | | failure | |
| 3 | Paraffin only | Lower than | 110 | 0.02 | 5 | 20 | Lower |
| | | 100 | | | | Adhesive | than 0.01 |
| | | | | | | failure | |
| 4 | 60% Paraffin, | Lower than | 110 | 0.02 | 8 | Greater than | Greater |
| | 28% | 100 | | | | 50, substrate | than 1.5, |
| | beeswax, | | | | | failure | substrate |
| | 12% Stearic | | | | | | failure |
| | acid | | | | | | |
| 5 | 60% Paraffin, | Lower than | 110 | 0.05 | 2 | Greater than | Greater |
| | 28% | 100 | | | | 50, substrate | than 2, |
| | beeswax, | | | | | failure | substrate |
| | 12% Stearic | | | | | | failure |
| | acid | | | | | | |
| 6 | No adhesive | — | 110 | 0.02 | — | Greater than | Lower |
| | | | | | | 35, weld | than 0.05, |
| | | | | | | failure | weld |
| | | | | | | | failure |

### Example 2

### A Low Melting Point Adhesive for Bonding a Polyethylene Film to a PVC Film

A mixture was prepared of 100 grams of Epolene™ E14, by Eastman, 100 grams beeswax, 10 grams of stearic acid amide and oleyl amine and 20 grams of terpene thenol tackifier Sylvares TP 2040 HM E, by Arizona Chemical. The mixture was blended at 110° C. The mixture exhibited a viscosity of about 100 centipoises at 150° C.

The adhesive was applied between a non-plasticized PVC film and a low density polyethylene (LDPE) film, and laminated at 110° C., under pressure of 0.01 MPa for 30 seconds. The adhesive was swollen by both substrates, and the laminated area was found to be flexible. Attempts to peel the two laminas away lead to substrate failure.

### Example 3

### A Low Melting Point Adhesive for Bonding a Polypropylene Film to a Polyamide 6 Film

A mixture was prepared of 50 grams of Licocene PP MA 1452, by Clariant, 75 grams paraffin wax, 10 of stearic acid and 20 grams of terpene phenol tackifier Sylvares TP 2040 HM E, by Arizona Chemical. The mixture was blended at 130° C. The mixture exhibited viscosity of about 150 centipoises at 150° C.

The adhesive was applied between a polypropylene random copolymer film and a polyamide 6 film, and laminated at 125° C., under a pressure of 0.02 MPa for 45 seconds. The adhesive was swollen by both substrates, and the laminated area was flexible. Attempts to peel the two laminas away, lead to substrate failure.

### Example 4

### Construction of Multilayers

Multilayered assemblies having a plurality of layers bonded to each other using the adhesive formulation disclosed herein may be obtained. The following embodiments are representative examples of multilayered assemblies manufactured according to the invention, employing the adhesive formulation of the invention.

It should be noted that for the sake of clarity, the thicknesses of the layers shown in the figures are not proportional and that the thickness of the adhesive material or adhesive layers is smaller as compared with the layers. In fact, as the adhesive impregnates the substrate, an adhesive layer between the bonded films is not to be expected. Two layers shown in the figures as having identical or similar thickness do not necessarily have the same thickness in all embodiments of the invention.

Additionally, while the assemblies shown are rectangular in shape, the assemblies prepared according to the invention may be of any shape.

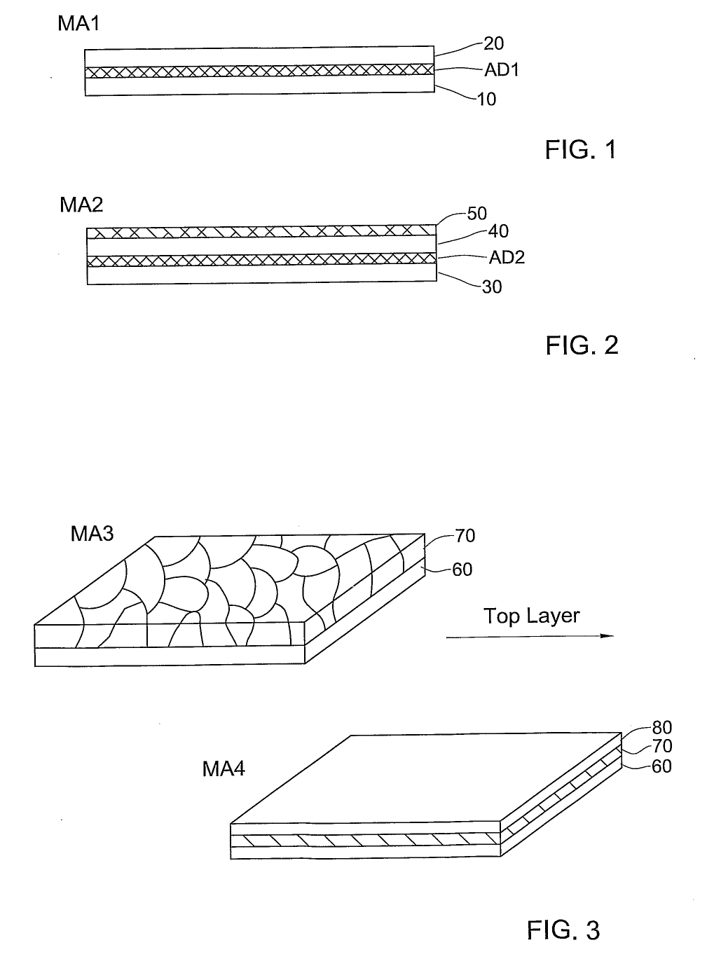

As shown in FIG. 1, a two-layered assembly MA1 is provided, manufactured by laminating a bottom skin layer 10 of a low density polypropylene (LDPE) with a top skin layer 20 of LDPE. The lamination of layer 10 is achieved by coating one face of said layer 10 with an adhesive formulation of the invention, AD1, and placing the top layer 20 on top. Alternatively, the adhesive may be applied to a face of layer 20 or to a face of layer 10 as well as to the face of layer 20.

It should be noted that while the assembly MA1 is in fact a laminate, the two layers may be bonded to each other through one or more non-continuous regions on their surfaces.

In this one example, the formulation of the invention is the formulation of Example 1 above.

Similarly, a two-layered assembly MA2, shown in FIG. 2, is an assembly having a first layer 30 and a second layer 40, bonded to each other with a layer or coat of beeswax-based formulation AD2. Top layer 40 is further coated, prior to pressing, with a thin layer of paraffin 50. The paraffin employed may be pure paraffin wax or contain an effective amount of stearine to achieve a desirable physical property such as hardness or flexibility. In some embodiments, the paraffin wax contains between 5 and 15% stearine by weight.

FIG. 3 provides an assembly MA3, which in the present example, employs a plurality of recyclable LDPE cuttings 70 which are soaked in a flowable adhesive, maintained at a temperature near its melting temperature, and then placed on a layer 60 of HDPE in such a way that the HDPE is completely or partially covered by the cuttings 70, as shown. The cuttings 70 are then covered with a skin layer of LDPE or HDPE 80, affording an assembly MA4, which is subsequently pressed for 40 seconds at a temperature between 90 and 150° C. The assembly thus obtained is a three-layer assembly of polyethylene which may be cut or shaped for future applications. In some cases, it is desirable that the layer 60 is darker in color and layer 80 is transparent so as the visual texture and/or coloring of the middle recyclable cuttings 70 is noticeable.

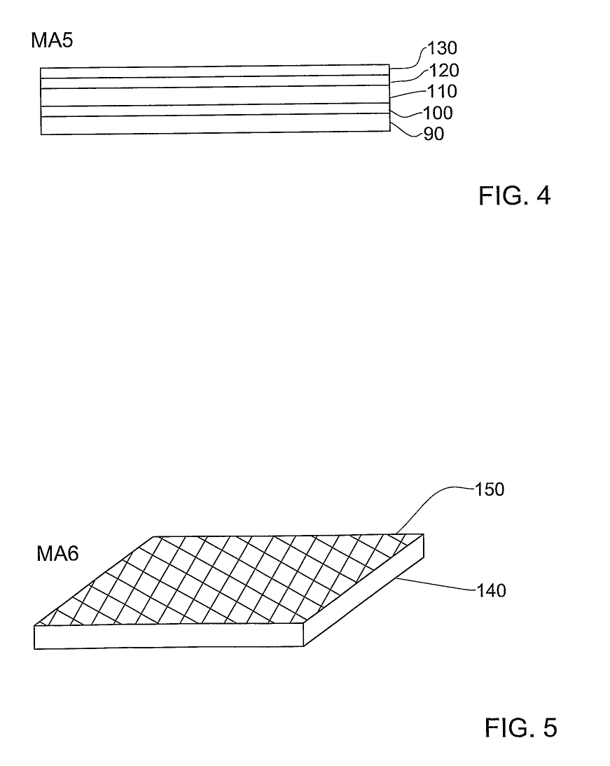

A further multilayered assembly MA5 of polyethylene layers is exemplified in FIG. 4. Such an assembly may be manufactured by placing onto each other two or more layers 90 and 100 of HDPE and/or LDPE, with no adhesive material between them, as shown in FIG. 4. On top of a layer 100 is placed a solid sheet 110 of an adhesive formulation of Examples 1, 2 or 3 and two or more layers 120 and 130 of HDPE and/or LDPE. The assembly is then pressed for 40 seconds as above, affording an assembly of 4 layers. Additional layers may be placed on top of skin layer 130 and/or below layer 90.

While FIG. 4 depicts a symmetric assembly having an even number of layers, asymmetric assemblies may also be manufactured.

The bonding of all layers together, employing only a single middle sheet of e.g., formulation of Example 1, depends on the thickness of the sheet. The thicker the multilayered assembly is, the thicker the adhesive film should be (namely, more formulation is required to achieve bonding of all layers).

The assemblies exemplified herein, may be treated prior to pressing (or heat pressing) or thereafter with gelatin so as to obtain an assembly with a skin gelatin layer. The application of gelatin to one or both of the skin layers of the assembly may be directly by brushing the surface with gelatin, spraying or dipping the assembly in gelatin, or indirectly by placing onto of the skin to be coated with gelatin a gelatin-soaked cloth and pressing the assembly and cloth as described hereinabove. Under the pressing conditions, the gelatin melts and forms a layer onto the face being in contact with the cloth. The process may similarly be repeated on the other face of the assembly.

The process of the invention may also be utilized in the formation of a reinforced assembly MA6 having reinforcing structures embedded therein. As demonstrated in FIG. 5, a polyethylene sheet 140 is reinforced with a polymeric or metallic mesh 150 and covered with a coat 160 of an adhesive formulation according to the invention (not shown). The adhesive coat 160 is then covered with a further polyethylene layer 170 (not shown) similarly to the described hereinabove regarding other embodiments of the invention. Before pressing, a cloth soaked with gelatin is placed on the assembly, and the assembly is heat-pressed for 40 seconds as described above, to thereby afford a reinforced multilayered assembly which may be cut or further processed to a final product.

Alternatively, the mesh of FIG. 5 may be replaced by a metallic sheet or other reinforcing material.

The multilayered assemblies of the invention may also comprise other layers such as gas-bather, adhesive, medical, flame retardant layers, and the like. Suitable materials for the optional layers include poly(vinylidene chloride), polyvinyl alcohol), polyamide (Nylon), polyacrylonitrile, ethylene-vinyl acetate copolymers (EVA), ethylene-methyl acrylate copolymers (EMA), ethylene-acrylic acid copolymers (EAA), ionomers, maleic anhydride grafted polyolefins, K-resins (styrene/butadiene block copolymers), and poly(ethylene terephthalate) (PET), the like, and mixtures thereof.

The multilayered assemblies manufactured according to the invention may be further processed by cutting, sowing or otherwise processing it as a single sheet for further applications.

The assemblies exemplified hereinabove are highly stable. The layers do not detach from one other. Attempts to mechanically detach the layers caused their tearing from the body of the multilayered assembly. The assemblies are water proof.

It should be appreciated by those skilled in the art that the conception and the specific aspects disclosed may be readily utilized as a basis for modifying or designing other assemblies and laminates for carrying out the same purposes of the present invention. It should also be realized by those skilled in the art that such equivalent constructions do not depart from the spirit and scope of the invention as set forth herein. Particularly, although the present invention is described generally in terms of a two-, three- or four-layered assembly, for purposes of convenience, the present invention encompasses multilayered assemblies with more than four layers.

1. A non-reactive adhesive formulation for bonding a first substrate to a second substrate, said formulation comprising:
(1) at least one low molecular weight material selected to have one or more of:
(i) chemical affinity towards at least one of said first and second substrates; and
(ii) a solubility parameter being substantially the same or one and a half (1.5) units greater or smaller than the solubility parameter of said at least one of said first and second substrates;
(2) at least one swelling promoter; and
(3) optionally at least one additive.

2. The adhesive formulation according to claim 1, wherein said at least one low molecular weight material is selected to have a chemical affinity towards at least one of said first and second substrates.

3. The adhesive formulation according to claim 1, wherein said at least one low molecular weight material is selected to have the ability to interact with at least one of said first and second substrates, said interaction being at least one of covalent bonding, ionic interaction, polar interaction and hydrogen bonding.

4. The adhesive formulation according to claim 1, wherein said at least one low molecular weight material is selected to have a solubility parameter as that of at least one of first and second substrates.

5. The adhesive formulation according to claim 1, wherein said at least one low molecular weight material is selected to have a solubility parameter 1.5 units greater or smaller than the solubility parameter of the at least one first and second substrates.

6. The adhesive formulation according to claim 1, wherein said at lease one low molecular weight material is a combination of two or more such materials, each having an averaged molecular weight of less than about 5,000 Da.

7. The adhesive formulation according to claim 6, wherein said averaged molecular weight is less than about 2,500 Da.

8. The adhesive formulation according to claim 6, wherein said averaged molecular weight is less than about 1,000 Da.

9. The adhesive formulation according to claim 1, wherein said at least one low molecular weight material having has an intrinsic viscosity of lower than 0.5 deciliter/gram at 135° C.

10. The adhesive formulation according to claim 1, wherein said at least one low molecular weight material is a solution in an at least one organic solvent having an intrinsic viscosity of lower than 0.5 deciliter/gram at 30° C.

11. The adhesive formulation according to claim 1, wherein said at least one low molecular weight material is selected from a natural origin wax, a fatty acid ester, a fatty acid amide, a fatty acid carbamate, a fatty alcohol ester, a fatty alcohol anhydride, a fatty alcohol salt, a fatty alcohol amide, a fatty alcohol carbamate, a dimerized or trimerized or polymerized fatty acid including esters or amides or carbamates thereof, amorphous propylene homopolymers; ethylene copolymers; and polybutene resins.

12. The adhesive formulation according to claim 11, wherein said at least one low molecular weight material is selected from Licocene™, Eastoflex™ P1010, Eastoflex™ M1010, Eastoflex™ E1060, and Eastoflex™ D178, Epolene™ E-20 and Epolene™ E-25, Licocene™ PEMA 4221 TP, PEOX 4241, and Indopol™H-6000.

13. (canceled)

14. The adhesive formulation according to claim 1, wherein said at least one swelling agent promoter is characterized by one or more of:
1. having a solubility parameter substantially the same as at least one of said first and second substrates; or a solubility parameter one and a half (1.5) smaller or greater than the solubility parameter of either the first or second substrate;
2. having the ability to promote swelling of said at least one first and second substrates at a temperature 20° C. above the peak annealing temperature or softening temperature of either of the substrates to 75° C. below; and
3. having the ability to lower the modulus of elasticity of said first or second substrates, measured 24 hours after bonding, by at least 5%.

15. The adhesive formulation according to claim 11, wherein said at least one swelling promoter has a molecular weight lower than 500 Da.

16. The adhesive formulation according to claim 11, wherein said at least one swelling agent promoter is selected form a fatty acid or a derivative thereof, a fatty alcohol or a derivative thereof, a polymerized fatty acid, an hydrogenated polymerized fatty acid, a paraffin oil, an oil, a plasticizer, a tackifier, wax and mixtures thereof.

17. The adhesive formulation according to claim 16, wherein said fatty acid is selected from stearic acid, oleic acid, linoleic acid, linolenic acid, Tall oil fatty acid, behenic acid and mixtures thereof.

18. (canceled)

19. (canceled)

20. The adhesive formulation according to claim 16, wherein said wax is selected from Beeswax, Japan wax, aliphatic amide waxes, fatty acid waxes, amine waxes, vegetable waxes, polyethylene waxes, synthetic paraffin waxes, hydroxylated fatty acid waxes, oxazoline waxes, microcrystalline waxes, modified microcrystalline waxes, oxidized mineral waxes and mixtures thereof.

21. The adhesive formulation according to claim 20, wherein said aliphatic amide wax is selected from stearamide wax, behenamide wax, and bis-stearamide wax.

22. The adhesive formulation according to claim 20, wherein said at least one swelling agent is selected form bamboo leaf wax, beeswax, caranda wax, Chinese insect wax, cotton wax, cranberry wax, asparto wax, Indian corn wax, Madagascar corn wax, ouricery wax, ozocerite wax, palm wax, peat wax, rice bran wax, shallas wax, sisal hemp wax, sorghum grain wax, Spanish moss wax, and refined sugar cane wax.

23. The adhesive formulation according to claim 1, wherein said at least one additive is selected from a diluent, an adhesion promoter, a heat stabilizer, a pigment, a dye, a light stabilizer, a filler, a fiber, a nanoparticle, a carbon black, a tackifier and a coupling agent.

24. The adhesive formulation according to claim 1, wherein said at least one diluent is selected from polybutene, paraffin oil, silicone oil, a vegetable oil, a plasticizer, and an organic solvent.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A process for bonding a first substrate to a second substrate, said process comprising:
(1) obtaining a first and a second substrates to be bonded to each other;
(2) applying a flowable form of an adhesive formulation according to claim 1 to at least a region of one or both of said first and said second substrates;
(3) optionally aligning one or both of said first and second substrates into contact with each other; and
(4) applying at least one of temperature and pressure to the first and second substrates being in contact with each other, at least at the region of desired bonding, to allow bonding of said first substrate to said second substrate.

39. The process according to claim 38, wherein said flowable form of said adhesive formulation is a liquid form thereof.

40. (canceled)

41. (canceled)

42. (canceled)

43. (canceled)

44. (canceled)

45. (canceled)

46. (canceled)

47. A multilayered assembly of at least two substrates bonded to each other through at least one region on the surface of the substrates, said bonding being provided by an adhesive formulation according to claim 1.

48. (canceled)

49. (canceled)

50. (canceled)

51. (canceled)

52. (canceled)

53. (canceled)

54. (canceled)

55. The assembly according to claim 47, having an adhesive layer characterized by one or more of:
(1) thickness of less than 10 micrometers; and
(2) penetration into each of the bonded substrates by at least 1 micrometer.

56. (canceled)
